(19) United States
(12) Patent Application Publication
(10) Pub. No.: US 2016/0104248 A1
(43) Pub. Date: Apr. 14, 2016

(54) System and Method for Distributing Risk Associated with the Cost of Purchasing Event Tickets

(71) Applicant: Milson Todd Armstrong, Irving, TX (US)

(72) Inventor: Milson Todd Armstrong, Irving, TX (US)

(21) Appl. No.: 14/513,028

(22) Filed: Oct. 13, 2014

(51) Int. Cl. G06Q 40/08

(52) U.S. Cl. CPC G06Q 40/08

(57) ABSTRACT

A system and method for distributing the risk associated with the cost of event ticket prices. A risk distribution system (RDS) is configured to receive information concerning a user's preferences associated with a sporting event, including the name of the event, the user's desired sports team, and the user's seating preferences. The RDS calculates a premium fee, utilizing statistical data associated with the probability that the user's selected team will participate in the event, as well as statistical information concerning the cost of any such payout to said user. Upon receipt of payment from the user, the RDS authorizes the issuance of a certificate of coverage setting forth terms and conditions upon which the user will be paid monetary funds towards the purchase of event tickets, or provided the event tickets. The RDS is further configured to evaluate claims and make payouts to users.

### BACKGROUND OF THE INVENTION

1. Technical Field

The present invention relates to systems and methods for distributing risk associated with the cost of purchasing event tickets.

2. Description of Related Art

Fans of individual and team sports are enthusiastic about supporting their respective teams. If possible, many such sports fans make efforts to purchase tickets to sporting events that feature their favorite teams. However, one problem that perennially plagues such fans is the high cost of event tickets, especially tickets to championship level events that are highly sought-after and therefore, high in price. Contributing to the high price of such event tickets is that with respect to many sports, it is not known which teams/individuals will participate in a championship level event until a short time prior to the event. At this time, often lasting only days or weeks, there is increased fervor among fans of the participating teams/individuals, leading to tickets often reaching exorbitant amounts. As a result, many fans desiring to attend such sporting events are left to the wild price swings seen in the secondary ticket market and amongst ticket scalpers. Therefore, a need exists for systems and methods for distributing risk associated with the cost of such event tickets.

### BRIEF DESCRIPTION OF THE SEVERAL VIEWS OF THE DRAWINGS

The novel features believed characteristic of the invention are set forth in the appended claims. The invention itself, however, as well as a preferred mode of use, further advantages thereof, will be best understood by reference to the following detailed description of illustrative embodiments when read in conjunction with the accompanying drawings, wherein:

FIG. 1 is a flow diagram illustrating an embodiment of an overall process of the risk distribution system;

FIG. 2 is a flow diagram illustrating an embodiment of a process of premium processing as depicted in the process shown in FIG. 1;

FIG. 3 is a flow diagram illustrating an embodiment of a process of assessing the probability of team participation as depicted in the process shown in FIG. 2;

FIG. 4 is a block diagram of an embodiment of the risk distribution system;

FIG. 5 is a block diagram of an embodiment of a computing device as may be utilized in connection with the risk distribution system;

FIG. 6 is a flow diagram illustrating an alternate embodiment of a process of the risk distribution system; and

FIG. 7 is a flow diagram illustrating an embodiment of a process of assessing ticket inventory and ticket ordering as depicted in the process shown in FIG. 6.

Where used in the various figures of the drawings, the same reference numerals designate the same or similar parts. All figures are drawn for ease of explanation of the basic teachings of the invention only; the extensions of the figures with respect to number, position, relationship, and dimensions of the parts to form the preferred embodiment will either be explained or will be within the skill of persons of ordinary skill in the art after the following teachings of the present invention have been read and understood.

### DETAILED DESCRIPTION OF THE DRAWINGS

Several embodiments of Applicant's invention(s) will now be described with reference to the drawings. Unless otherwise noted, like elements will be identified by identical numbers throughout all figures. The invention(s) illustratively disclosed herein suitably may be practiced in the absence of any element that is not specifically disclosed herein.

Systems and methods for distributing risks associated with the costs of event tickets are disclosed herein. While the embodiments discussed herein are associated with sporting events, the principals taught below could also be applied to other types of non-sporting event tickets as well, including tickets for events that may or may not occur, with contingent participants that may or may not participate in said event, as well and in connection with tickets for definite events (events that are planned to occur) with contingent event participants. Regardless of the particular type of event to which the teachings herein are applied, the systems and methods discussed below are intended to improve the means by which the risk of bearing costs associated with tickets for events having unknown participants, may be optimally distributed and managed.

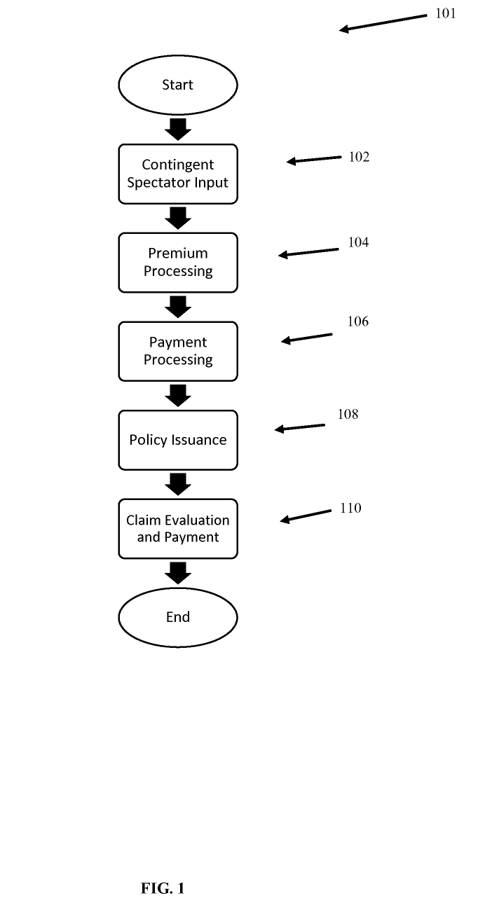

Referring now to FIG. 1, a flow diagram illustrating an embodiment of an overall process of the risk distribution system (“RDS”) disclosed herein. It should be noted at the outset that although the methods discussed herein differ in many respects from methods employed in providing many traditional types of insurance, much of the same terminology (for example, “premium,” “policy,” and “claim”) is equally descriptive of certain aspects of the systems and methods of the RDS and thus, will be utilized herein. Still referring to FIG. 1, a user of the system may be an individual or entity that seeks to lower the risks associated with high ticket prices for sporting events, primarily for events that are planned to occur but for which it is unknown (for a period of time) which team or individuals will participate in such events. By way of a non-limiting illustrative example of such an event, the College Football Playoff Championship Game is scheduled to occur in January of each year but the identities of the two football teams that will participate in such game remains unknown until such time as the respective outcomes of prior playoff events become known. As a result, it is risky for a football fan of any particular college football team to expend funds to purchase tickets to the Championship Game until such time as the actual participants are known, which typically occurs mere days or weeks before the Championship Game is scheduled to occur. At such a late date, ticket prices for the Championship Game have often increased beyond the reach of many fans. Therefore, a need exists for such fans to distribute the risks associated with such high ticket prices to other individuals and/or entities, which is one object of the RDS disclosed herein.

It should be noted that although the “user” of the RDS as disclosed in the embodiments discussed herein are individual contingent spectators (college football fans that desire to attend a sporting event if their favored team is an event participant), it is contemplated that other users may include other non-contingent spectator individuals or entities that have already borne risk associated with the cost of tickets prices for events, and seek to further distribute that risk to other third parties. By way of example of such an entity that does not intend to actually attend an event, a user of the RDS may include an entity that is contractually liable to one or more individual contingent spectators to provide such individuals with event tickets (or money intended to cover all or a portion of the price of such event tickets) should their favored team participate in such event. Under such circumstances, the entity user of the RDS would utilize the RDS to distribute the risks associated with its own primary contractual liability to a third party (in this example, the third party to which the risk is at least partially borne is the enterprise provider of the RDS or “RDS provider”).

Still referring to FIG. 1, the first step of an embodiment of the RDS process is the user initiating communications, via a computing device transmitting and receiving data over a communications link such as a network, with the RDS to provide information 102 regarding the contingent event spectator and the selected event. The RDS preferably includes a web-based user interface for receiving a user's input. The RDS will request that the user supply certain identifying information concerning the user as a condition of using the RDS. For example, the user will preferably be required to enter his/her/its name and contact information (including at least an email address associated with the user). The user will also preferably be required by the RDS to select a unique login name and password, which can later be utilized to authenticate the user's identity to gain access to portions of the RDS intended to be displayed to a user via a user interface. The RDS may also require the user to provide payment information (credit/debit card information). The foregoing information will be used by the RDS to generate a unique user account for each user, to be stored in an enterprise database as discussed in further detail below. It should be noted that in alternate embodiments of the RDS, a user may not be required to supply the types of identifying information discussed above, until after a premium is calculated and displayed to said user.

Information requested from a user concerning the contingent spectator preferably includes the name of the desired sporting event (for example, Super Bowl, College Football Playoff Championship Game, World Series, etc.) and the name of the favored/desired sports team (may be referred to herein as the user's “contingent sporting event participant”). Other information that may optionally be requested from a user may include the contingent spectator's preferred seating tier. For example, the user may be requested to select a preferred seating tier for the particular event being held at a particular event venue. Examples of seating tiers may include upper-level, mezzanine, lower-level, end zone, depending on the particular stadium seating configuration where the selected event will be held. If the event venue is unknown at the time the user is requested to input such information, the user may be provided with generic types of seating tiers from which to select a preferred seating tier. Other optional information that may be requested of a user to input into the RDS may include other terms that are common in insurance policies such as preferred deductible amounts and preferred policy limits (maximum payout amount).

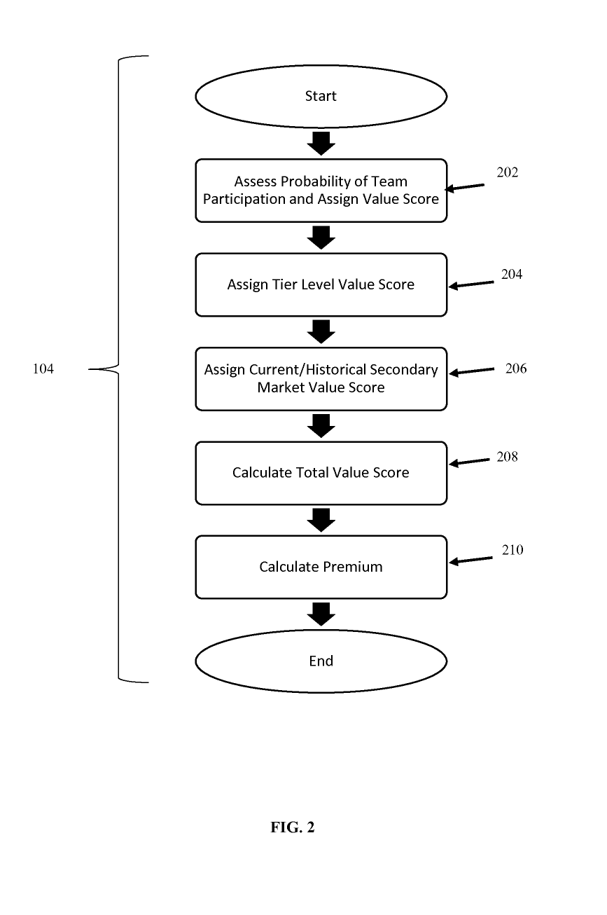

After the user has inputted information concerning the contingent spectator's preferences and the particular desired event, the RDS next processes 104 such inputted information and other information (discussed in more detail with reference to FIG. 2) to calculate a premium fee to be charged to the user in order to authorize the issuance of a certificate of coverage, which may or may not constitute a binding contract, for the distribution of risk associated with event ticket prices. While the embodiments of the RDS discussed herein are directed to the calculation of premium fees based on the selection of single events and single teams, the underlying principals of the RDS as taught herein could similarly be applied to distributing risks associated with the cost of tickets for multiple events and multiple desired teams (for example, a contingent spectator may seek to utilize the RDS to distribute risks associated with ticket prices in connection with multiple favored NFL teams for which he/she would desire to attend the Super Bowl in the event that such teams were to participate). Those with skill in the art will recognize that it would be necessary to modify the manner in which premiums are calculated should multiple teams be selected, in order to take into account the likely increased probability of one or two of multiple desired teams selected by a user participating in a selected event.

Payment of the premium fee by a user, typically constituting a specified amount of monetary funds, serves as consideration for the RDS provider (or another third party associated with the RDS provider) to authorize the issuance of a certificate of coverage to the user (or third party associated with user) to bear at least a portion of the risk associated with the cost of event tickets should the conditions of said certificate of coverage be met (the user's desired sports team is a participant in the sporting event selected by the user). In some embodiments of the RDS, the RDS provider or a third party will enter into a binding contract with the user, the terms of said binding contract relating at least partially to the terms of the certificate of coverage authorized for issuance by the RDS provider.

The user is next provided by the RDS with a means of making payment of the premium fee. The RDS preferably includes a web-based user interface for receiving a user's credit or debit card payment information. Alternatively, the RDS may redirect a user to a remote third party online payment vendor (for example, PayPal®) to make a premium payment that is linked to an account owned by the RDS provider (or other third party associated with the RDS provider). In other alternate embodiments, the RDS may invite the user to pay the premium fee by other known payments means (check, cash, money order, etc.).

Following payment of the premium fee by the user, the RDS will issue 108 a certificate of coverage (also known as a “policy”) that sets forth the obligations of the user (or third party associated with the user) and RDS provider (or other third party associated with the RDS provider), and the conditions upon which a payout to the user will be made. It is further contemplated that in alternate embodiments of the RDS, a certificate of coverage, contract or other policy may be issued by a third party and not the RDS provider. The RDS will preferably make the certificate of coverage available for viewing to the user via a web-based user interface. Alternatively, the RDS may transmit the certificate of coverage to the user or a third party via electronic mail. Other known methods of transmitting the certificate of coverage, electronically or in physical format, may alternatively be utilized by the RDS.

Following the issuance of the certificate of coverage, the RDS will be accessible by a user to submit 110 claims under such certificate of coverage. Preferably, the RDS will be configured to notify the user of the ripeness of any claim if said user's desired team under the certificate of coverage is to participate in the user-selected event under said certificate of coverage. Such notification of the user by the RDS will preferably be by means of electronic mail to the email address associated with the user's RDS account. Alternatively, the RDS may be configured to require a user to submit a claim to the RDS, via a web-based user interface, as a condition to receiving payment under the certificate of coverage.

In one embodiment, the RDS is configured to communicate, via a network, with an electronic database/server that serves as a statistical data source having periodically updated information concerning the identities of sports teams that will play in particular sporting events. The RDS is configured to periodically (or alternatively, at predetermined times) transmit requests to the statistical data source for information concerning the identities of teams that are set to participate in certain sporting events for which the RDS has issued certificates of coverage to users. The RDS is configured to receive and store such identifying information from the statistical data source, and to utilize such information to determine whether the terms of the certificates of coverage have been satisfied such that a payout to a user should occur. Alternatively, such information may be utilized by the RDS to evaluate claims submitted by one or more users. In other embodiments of the RDS, the types of information described herein that may be stored and transmitted from a statistical data source, may be compiled from such statistical data sources or other third party statistical sources by personnel associated with the RDS provider, and stored in storage devices (local storage, cloud storage, etc.) associated with the RDS provider.

If upon evaluation of a claim by the RDS, the RDS determines that the conditions of a payout to a user under the user's certificate of coverage have been satisfied (for example, the user's desired team will participate in the user-selected sporting event and the user completes the required claims request process), the RDS will initiate a payment transaction to the user. It should be noted that the particular method of the RDS making a payout under a certificate of coverage will vary depending upon the particular terms of the user's certificate of coverage. In one embodiment of the RDS, the RDS will transmit an order to the RDS provider's financial department to prepare and send a check or money order for a fixed amount of money, to be mailed to the user to serve as funds or compensation for the purchase price of a ticket(s) to the user's selected sporting event on the primary or secondary ticket market. It is contemplated that in other alternate embodiments of the RDS, payment transactions between the RDS provider, users, and other third parties, may occur via any non-electronic or electronic payment method such as, for example, e-wallet, wire transfer, ACH debit/credit transfer, credit/debit card, check, money order and cash.

In other embodiments, the RDS will be configured to transmit instructions to make payment of an amount of money that depends on the current market value of a ticket to the user-selected event. In such an embodiment of the RDS, the RDS will be configured to transmit a request, via a network, to an electronic data source such as a server associated with a ticket distributor, requesting current pricing information associated with tickets to the user-selected sporting event. Further such a request from the RDS may request information from the ticket distributor regarding pricing information associated with certain tiers of seating at the particular venue of the user-selected event, such information corresponding to the user's previously selected seating preferences. The RDS will be configured to receive such pricing information from the ticket distributor server in a machine-readable format or data structure. Once received, and depending on the terms of the particular user's certificate of coverage, the RDS may calculate an amount less than the full price of the ticket (from the ticket distributor) to serve as a payout to be sent to the user.

In other alternate embodiments of the RDS, the RDS may be configured to transmit an instruction to the RDS provider to send an appropriate quantity of tickets for the user-selected event, having seats in a user preferred seating tier, directly to the user at an address (or electronically to a user provided email address) provided by the user. In even other alternate embodiments of the RDS, the RDS may be configured to transmit an order, via a network, to a ticket distributor for the purchase of appropriate tickets to a user-selected event, having seats in a user-preferred seating tier, the RDS instructing the ticket distributor to send physical or electronic tickets directly to the user. In alternate embodiments of the RDS, the ticket distributor may be instructed to send physical or electronic tickets to the RDS provider for further shipment to the user.

It should be noted that the RDS may be configured to set forth certain maximum payout amounts within the terms of all or a portion of certificates of coverage issued to users. In such cases, payout amounts of monetary funds to users will be limited by such specified maximum payout amounts.

Referring now to FIG. 2, a flow diagram illustrating an embodiment of a process of by which premium fees may be calculated 104 as depicted in FIG. 1. In one embodiment, the RDS calculates 104 a premium for a particular user by utilizing both user-supplied information, as well as other statistical information that corresponds to either the probability that a payout will occur, or corresponds to tickets costs should a payout occur. Although those of skill in the art will recognize that premium fees may be calculated by numerous methods, taking into account numerous variables, the RDS is preferably configured to assess the variables bearing on payout probability and payout costs, and to assign such variables proprietary value scores so that multiple types of differing variables may be utilized together. Once calculated, the RDS may apply various weighting to the value scores, depending on the importance attributed to such value scores by the RDS provider. The RDS may be configured to sum or average such value scores, which may then be used to calculate a premium fee (for example, via a lookup table that associates total or average value scores with corresponding premium amounts).

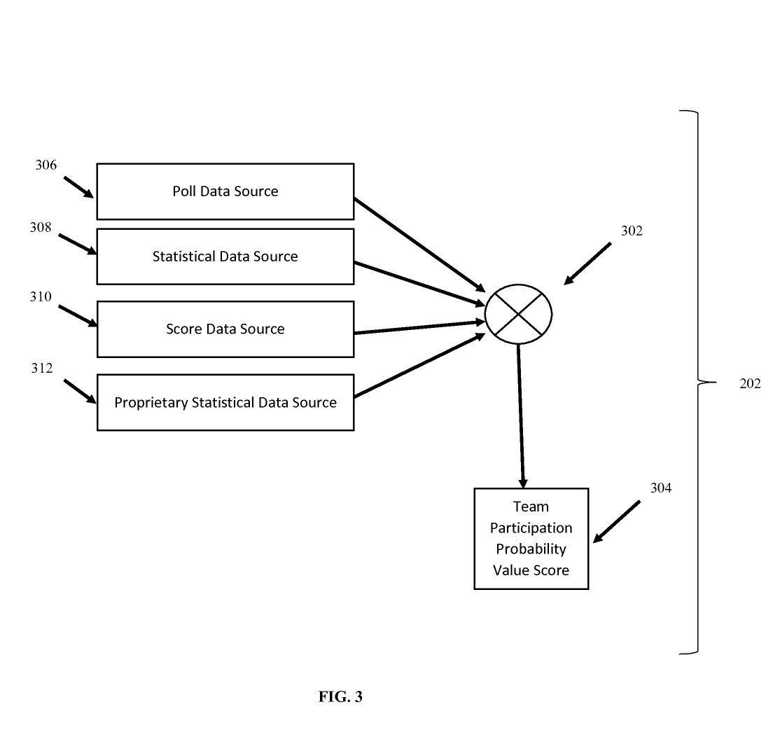

One variable that is preferably taken into account by the RDS in calculating a premium fee is the probability that the user's desired team (contingent sporting event participant) will ultimately participate in the user-selected sporting event. The RDS is configured to receive information concerning such probability, assess the probability of the occurrence of such event, and assign a proprietary value score to such probability 202. Referring now to FIG. 3, a flow diagram illustrating an embodiment of a process of assessing 202 the probability of team participation as depicted in the process shown in FIG. 2, the RDS is configured to receive data bearing on the probability that the user's desired team will participate in the user-selected event from multiple data sources via a network.

One source of such data is from a poll data source 306. Sporting polls such as, for example, the Associated Press's weekly college football poll, provide ranking information associated with certain high-ranking college football teams. Poll ranking associated with a certain team may be utilized by the RDS to assign a value score bearing on the probability that such team will be a participant in the user-selected event. By way of example, there is a relatively high probability that a team ranked in the Associated Press's top five college football teams at a time near the end of the college football season, will participate in the Championship Game.

Another source of such data that may correspond to the probability that a user's desired team will participate in a user-selected event may include data received from a statistical data source 308 such as a server/database storing and transmitting sporting related statistics such as are utilized by gaming enterprises to set odds for betting on sporting events. Such statistical data associated with a certain team may be utilized by the RDS to assign a value score bearing on the probability that such team will be a participant in the user-selected event.

Another source of such data that may bear on the probability that a user's desired team will participate in a user-selected event may include a score data source 310. Real-time or periodically updated score data may be transmitted to the RDS for utilization in calculating a value score associated with the probability that a certain user desired team will participate in a user-selected event. Other proprietary statistical data sources 312 may be utilized by the RDS in assigning an overall value score to the probability that the user's desired team will participate in the user-selected event. A value score assigned to the data received from any data source may be weighted by the RDS according to the importance given such data by the RDS provider. A total team participation probability value score 304 will then be calculated 302 by the RDS. The total team probability value score may be a sum of the weighted value scores (from the data sources) or an average of such weighted value scores.

Referring back to FIG. 2, other information may be utilized by the RDS to calculate the premium fee to be quoted to the user. For example, ticket pricing information corresponding to the user's preferred seating tier may be utilized to calculate the premium fee. For example, if a user indicates that he or she prefers tickets for seats on lower tiers of a stadium seating configuration, between the forty yard lines, the RDS will preferably be configured to calculate a higher premium as opposed to a user that indicates that he or she prefers upper-level end zone seats. The RDS is configured to assign a proprietary value score 204 to the user's seating preferences. Such seating preference related value scores may also take into account the particular sporting event venue selected by the user.

Other information that is preferably utilized by the RDS in calculating a premium fee is current and historical pricing data for the particular event and team selected by a user. It is known that ticket pricing varies depending on the particular event. It is also known that ticket pricing varies depending on which particular teams participate in certain events. By using current and historical pricing information regarding the user-selected event and team, the RDS may more accurately calculate an appropriate premium fee. Such current and historical pricing information regarding the user-selected event and team may represent proprietary data or alternatively, data received from an outside data source such as a ticket distributor or online ticket retailer. Other information that may be utilized by the RDS in calculating a premium fee may include an RDS or user-selected maximum payout amount, a user-selected deductible amount, or any other variable the RDS provider deems a consideration in calculating the premium fee. Examples of other such variables that may used to calculate the premium fee may include payment transaction fees (for example, credit card merchant fees) and the desired profit margin of the RDS provider.

Following the assignment of value scores to each of the individual variables bearing on probability of payout and costs associated with payout, the value scores may be weighted (according to importance as defined by RDS provider) and processed (for example, by summing or averaging) to arrive at a total value score 208. A premium fee may be calculated based on the total value score by any known methods for associated a value score to a premium. For example, a premium fee amount may be derived by the RDS from a total value score by utilizing a lookup table (associating total value scores with corresponding premium fee amounts) or alternatively, applying a multiplier to the value score.

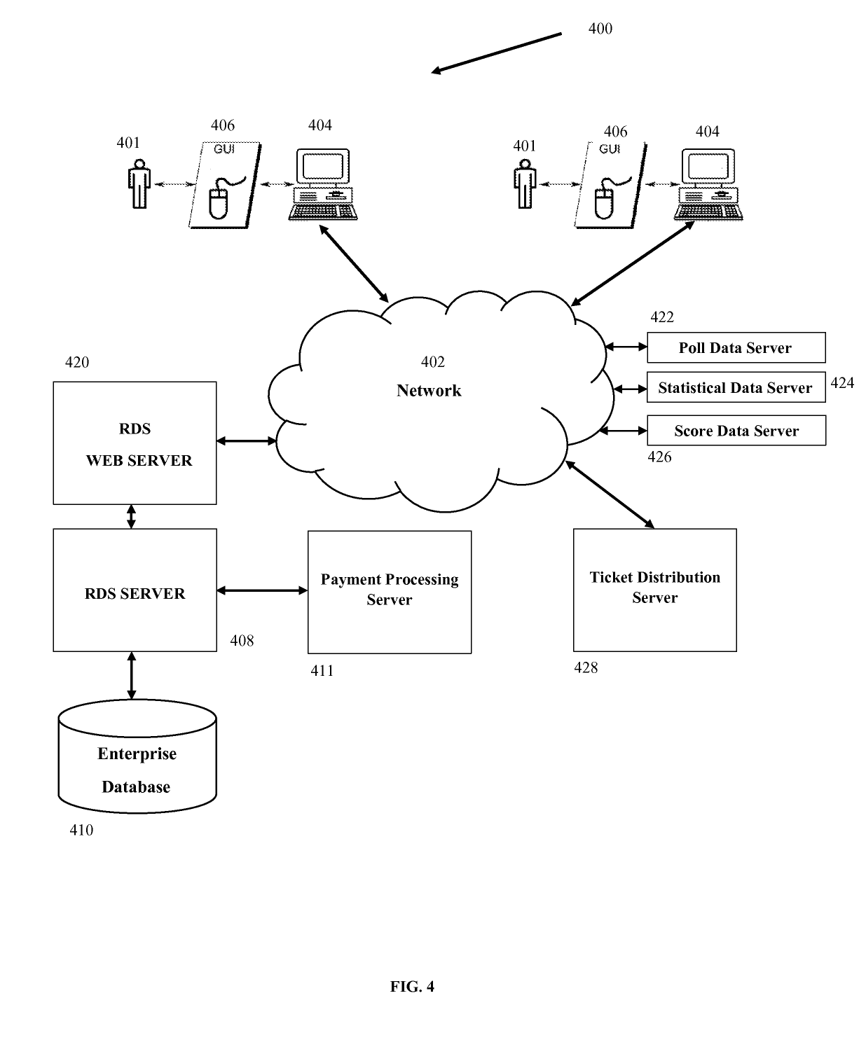

An RDS through which an enterprise insurer (“RDS provider”) communicates with individuals and/or entities seeking to distribute risks associated with the cost of purchasing event tickets via short-term insurance certificate of coverage, and also by which such enterprise insurer creates and manages such certificate of coverage, is implemented in one exemplary embodiment as depicted in FIG. 4. In one embodiment, the RDS operates over a wide area communication network such as the Internet, a description of an exemplary network and corresponding components is provided as FIG. 4. In FIG. 4, an exemplary network 400 is shown according to the disclosed embodiments. As can be seen, the network 400 may have a plurality of client computing devices 404 connected to, for example, a risk distribution system (RDS) server 408 hosted by at least one web server 420 with an enterprise database 410 connected thereto.

The plurality of client computing devices 404 may be any system, device, and/or any combination of devices/systems that are able to establish a connection with another device, a server and/or other systems. Client computing device 404 typically includes display or other output functionalities to present data exchanged between the device and a user. For example, the client devices may be, but are not limited to, a server, a desktop computer, a computer duster, a mobile computing device such as a notebook, a laptop computer, a handheld computer, a mobile phone, a smart phone, a PDA, an iPhone, etc. In one embodiment, the client devices 404 are coupled to the network 402 such that a communication link is established between the RDS and the client computing device. In some embodiments, the client computing devices may be directly connected to one another. In the example shown, the computing devices 404 represent individual users or entities (i.e., insureds or potential insureds) who are investigating the distribution of risk associated with the cost of tickets to a sporting event, or have already received a certificate of coverage from the RDS provider and are in need of communicating with the provider regarding some aspect of said certificate of coverage (for example, making payment or submitting a claim).

Each computing device 404 may connect to a RDS website via associated web server 420 over a communication link such as a network connection which may be a telephone line connection, high speed broadband connection, or wireless connection, or combinations thereof. Of course, those of ordinary skill in the art will recognize that the types of computing devices and associated network connection may vary without departing from the scope of the disclosed embodiments. The RDS provider may connect to the RDS server 408 and ultimately reach users through client computing devices 404 over network 402. Network 402 may be a telephonic network, an open network, such as the internet, or a private network, such as an intranet and/or the extranet. Network 402 may be a collection of various individual networks op conjunction to provide connectivity to the client devices and servers, and may be recognized as one or more networks to the serviced systems and devices. Connectivity may be established by a secure communication protocol. In another embodiment, communication may be achieved via one or more wireless networks. Client computing devices 404 may be coupled to network 402 via the internet, dial-up connection, digital subscriber loop (DSL, ADSL), cable modem, and/or other types of connection. Client devices 404 may communicate with remote servers that provide access to user interfaces to the Internet via a web browser.

Associated with the RDS server 408 is an enterprise database 410. Enterprise database 410 may store information such as software, statistical data, images, system information, user information and information relating to certificates of coverage, drivers, and/or any other data item utilized by the web server 420 and RDS server 408. Enterprise database 410 may be managed by a database management system (DBMS), for example but not limited to, Oracle. DB2, Microsoft Access, Microsoft SQL Server, PostgreSQL, MySQL, FileMaker, etc. RDS 408 manages and delivers insurance options to requesting users via network 402.

The enterprise database 410 associated with RDS 408 also includes user account information, user login/password information and in one embodiment various selection information and user preferences that enable RDS 408 to calculate a premium for such user as discussed herein. In one embodiment, the RDS 408 creates a user profile stored in the enterprise database 410 corresponding to the identifying information and preferences supplied by the user. RDS 408 uses the profile information to present the user at client device 404 with options for event tickets and various insurance policy options.

RDS 400 may utilize a username/email and password identification method for authorizing access. In other embodiments, other forms of identity authentication, such as security cards and/or digital certificates may be utilized. A user may be able to specify and/or obtain a login ID after subscribing with RDS. The RDS server 408 may also establish communication sessions with a social network platform (not shown) to transmit customized advertisements for displaying information about ticket insurance policies to potential insureds. The RDS server 408 may also establish communication sessions with online sources for obtaining event tickets (not shown), to transmit customized advertisements for displaying information about ticket insurance policies to potential insureds.

The software agents and/or hardware components of the RDS server 420 also enables appropriate charging of users based on premium commitments by a user. Specifically, based on information provided to the enterprise insurer, and upon calculation of a premium by said insurer, the user will be quoted such premium fee to render an insurance policy effective. If a user received a certificate of coverage from the RDS provider (or third party associated with the RDS provider), the RDS server will charge the user for the appropriate amount either through charging a credit or debit card provided by the user or through other fund transfer means. A payment processing server 411 may be utilized to communicate data associated with premium payments, between the RDS server 408 and servers and other computer devices associated with credit/debit card providers and processors (not shown). It is contemplated that in alternate embodiments of the RDS, one or more operations/tasks described herein to be performed by the RDS server 408, may be performed by the RDS web server 420.

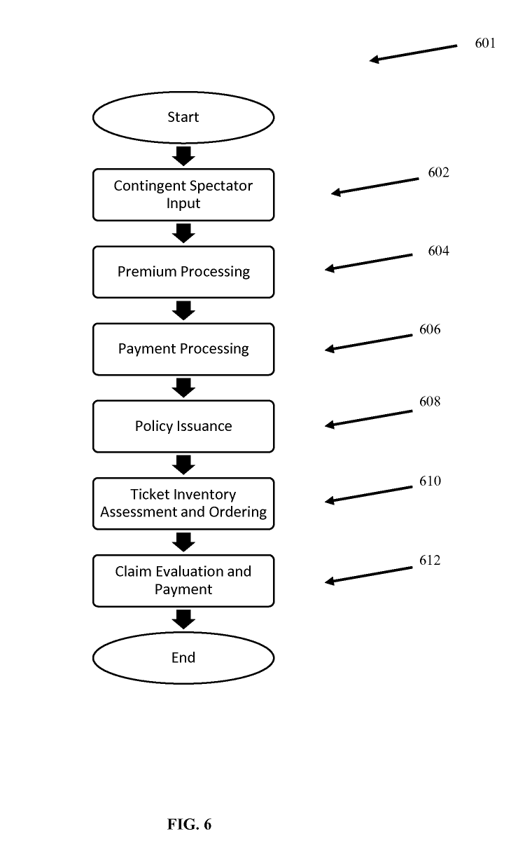

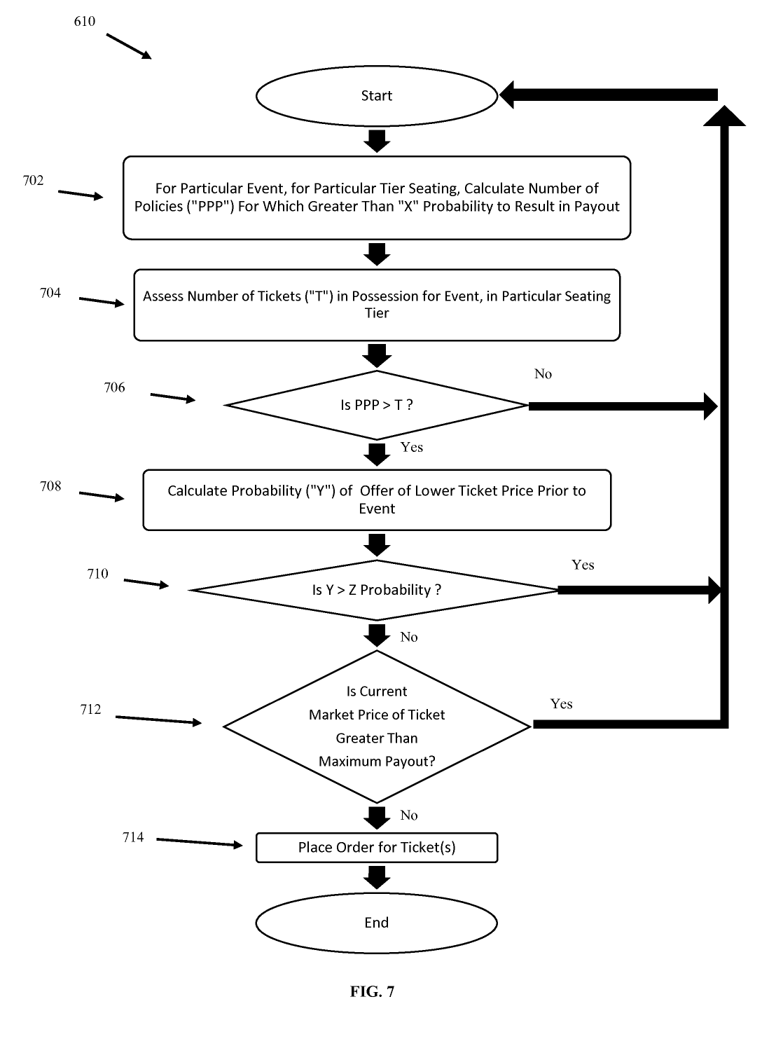

The RDS server is also configured to communicate, via a network 402, with one or more data source constituting servers/databases from which information may received that enables the RDS to calculate user premium fees. Examples of such data sources include poll data 422, statistical gaming data 424, and sporting scores data 426. The RDS server is also preferably configured to communicate, via a network 402, with a server/database associated with a ticket distributor 428 or other ticket retailer. As discussed further herein, the RDS may utilize such a communication link to both receive information regarding current and historical ticket pricing and pricing trends, and also to transmit instructions for the purchase of particular tickets. The purchase of such tickets may occur as a result of a need to provide a payout to a user under a certificate of coverage. Alternatively, and as discussed with reference to the alternate embodiment processes depicted with reference to FIG. 6 and FIG. 7 below, the purchase of such tickets so as to increase the RDS provider's ticket inventory for a particular event/seating tier, may be a cost-effective means for reducing overall future RDS provider payout costs.

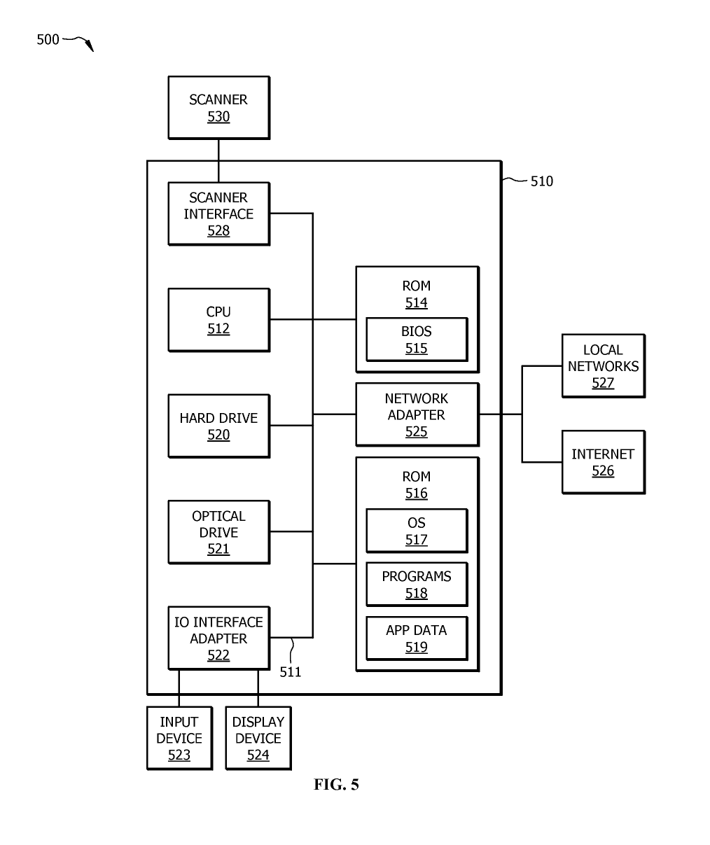

Referring now to FIG. 5, a preferred exemplary block diagram of a 500 client computing device (also represents an exemplary block diagram of an RDS server) on which exemplary processes of the present disclosure can be executed according to one embodiment of the present invention. In general, the system 500 includes a computing device 510 (may be referred to as a “computer”). One example of the computing device 510 includes a processor unit 512, read only memory (ROM) 514, random access memory (RAM) 516, and a system bus 511 that couples various system components including the RAM 516 to the processor unit 512. The system bus 511 may be any of several types of bus structures including a memory bus or memory controller, a peripheral bus and a local bus using any of a variety of bus architectures. A basic input/output system 515 (BIOS) is stored in ROM 514. The BIOS 515 contains basic routines that help transfer information between elements within the computing system 510.

The computing system 510 can further include a hard disk drive 520 for reading from and writing to a hard disk, a magnetic disk drive (not shown) for reading from or writing to a removable magnetic disk, and/or an optical disk drive 521 for reading from or writing to a removable optical disk such as a CD ROM, DVD, or other type of optical media. The hard disk drive 520, magnetic disk drive, and optical disk drive 521 can be connected to the system bus 511 by a hard disk drive interface (not shown), a magnetic disk drive interface (not shown), and an optical drive interface (not shown), respectively. The drives and their associated computer-readable media provide nonvolatile storage of computer readable instructions, data structures, programs, and other data for the computing system 510.

Although the example environment described herein employs a hard disk drive 520, a removable magnetic disk, and removable optical disk drive 521, other types of computer-readable media capable of storing data can be used in the example system. Non-limiting examples of these other types of computer-readable mediums that can be used in the example operating environment include magnetic cassettes, flash memory cards, digital video disks, solid state disk drives, and Bernoulli cartridges.

A number of program modules may be stored on the ROM (514), RAM (516), hard disk drive 520, magnetic disk drive, or optical disk drive 521, including an operating system 517, one or more application programs 518, other program modules, and program (e.g., application) data 519.

A user may enter commands and information into the computing system 510 through input devices 523, such as a keyboard, touch screen, and/or mouse (or other pointing device. Examples of other input devices 523 may include a microphone, joystick, game pad, satellite dish, and document scanner. These and other input devices are often connected to the processing unit 512 through an I/O port interface 522 that is coupled to the system bus 511. Nevertheless, these input devices 523 also may be connected by other interfaces, such as a parallel port, game port, or a universal serial bus (USB). A monitor 524 or other type of display device is also connected to the system bus 511 via an interface, such as the IO interface 522. In addition to the display device 524, computing systems typically include other peripheral output devices (not shown), such as speakers and document printers.

The computing system 510 may operate in a networked environment using logical connections to one or more remote computers. The remote computer may be a personal computer, a server, a router, a network PC, a peer device or other common network node, and typically includes many or all of the elements described above relative to the computing system 510. In certain embodiments, the network connections can include a local area network (LAN) or a wide area network (WAN). Such networking environments are commonplace in offices, enterprise-wide computer networks, intranets, and the internet 526.

When used in a WAN networking environment, the computing system 510 typically includes a modem, Ethernet card, or other such means for establishing communications over the wide area network, such as the Internet 526. The modem or other networking components, which may be internal or external, can be connected to the system bus 511 via a network interface or adapter 525. Network adapter 525 may be one or more networking devices that enable RDS 108 to transmit data in a network with an entity that is external to the server, through any communications protocol supported by the server and the external entity. Network adapter 525 may include, but is not limited to, one or more of a network adaptor card, wireless network interface card, router, access point, wireless router, switch, multilayer switch, protocol converter, gateway, bridge, bridge router, hub, digital media receiver, and/or repeater.

When used in a LAN networking environment, the computing system 510 is connected to the local network 527 through the network adapter 525. In a networked environment, program modules depicted relative to the computing device 510, or portions thereof, may be stored in the remote memory storage device. It will be appreciated that the network connections shown are exemplary and other means of establishing a communications link between the computers may be used.

Referring now to FIG. 6, a flow diagram illustrating an alternate embodiment of a process of the risk distribution system (“RDS”), said process including the steps of the process depicted in FIG. 1, and further including an additional step of assessing ticket inventory and preemptively ordering 610 additional tickets if it is anticipated that the quantity of tickets in inventory (accessible to the RDS provider) will be insufficient to adequately cover expected payouts to users under certificates of coverage. For example, in alternate embodiments of the RDS, a term of a certificate of coverage entered into between the RDS provider (or third party associated with RDS provider) and a user (or third party associated with user) may require a payout from the RDS provider to the user to constitute actual tickets to the user-selected sporting event. In the event that multiple users have entered into such certificates of coverage for a particular event, regardless of whether the users have selected different or identical teams, it may reduce the overall payout costs of the RDS provider to maintain an inventory of tickets in its possession so that it may provide such event tickets as a payout to the users (having selected teams that actually will participate in the event) without it being necessary to pay possibly higher prices for tickets on the primary or secondary ticket market in the days leading up to the actual event. The additional step of ticket inventory assessment and ordering performed by an alternate embodiment of the RDS represents an improvement over any existing insurance methods in that it further reduces potential payout costs.

Referring now to FIG. 7, a flow diagram illustrating an embodiment of a process of assessing ticket inventory and ticket ordering 610 as depicted in the process shown in FIG. 6. The first step performed by the RDS in assessing ticket inventory with the possibility of ordering additional tickets is to calculate 702 the quantity of policies entered into by the RDS provider having a high probability (in excess of some predetermined “X” probability as determined by the RDS provider) of resulting in a ticket payout. A suitable probability value “X” assigned to such analysis is preferably 0.5 (50%) but other probability values may be selected by the RDS provider. For each policy that the RDS calculates as constituting a high probability of requiring a ticket payout, the policies should be categorized by event and further by the type of tier seating preferred by the user associated with such policies. The RDS is then configured to assess 704 the number of tickets in its inventory for each such event/seating tier (corresponding to the event/seating tier information associated with policies constituting a high probability of ticket payout).

Still referring to FIG. 7, the quantity of each probable payout policy (“PPP”) is then compared 706 by the RDS to the RDS provider's ticket inventory (“T”) corresponding to tickets which will be required to be provided should RDS be required to make ticket payouts to the user's associated with the PPPs. For each ticket category (event/seating tier), if the PPP is not greater than T, no action should be taken other than to continue periodically re-calculating the assessment. For each ticket category (event/seating tier), if the PPP is greater than T, the RDS is then configured to calculate an approximate probability “Y” that a lower ticket price will be offered between the time of the assessment and just prior to the start of the event. The RDS may be configured to analyze current and historical ticket sales trends for a particular sporting event to determine whether it is more cost-effective to delay ticket purchases or move forward with the ticket purchases. The RDS is configured to subsequently compare whether Y probability is greater than some predetermined “Z” probability value. A suitable probability value “Z” assigned to such analysis is preferably 0.5 (50%) but other probability values may be selected by the RDS provider. If the RDS calculates Y to exceed Z, then no further action is necessary other than to periodically perform the same assessment step 610.

If the RDS calculates Y to not exceed Z, then the RDS must further determine whether the cost of any ticket to be purchased on the primary or secondary market exceeds an agreed upon maximum payout under each particular corresponding certificate of coverage. If such a purchase of a ticket would exceed a maximum payout amount under a certificate of coverage, no further action is to be taken other than to periodically perform the same assessment step 610. If the cost of a ticket would not exceed a maximum payout amount, the RDS is configured to transmit an instruction, via a network, to the RDS provider or preferably, a ticket distributor, for the purchase of a ticket(s) corresponding to the PPP. Upon receipt of the tickets from the ticket distributor, the RDS enterprise database will be updated to correctly identify the quantity of tickets (for each event/seating tier) in RDS inventory.

It should be noted that the description of the present invention has been presented for purposes of illustration and description, and is not intended to be exhaustive or limited to the invention in the form disclosed. Many modifications and variations will be apparent to those of ordinary skill in the art. The preferred embodiment appearing in the drawings was chosen and described in order to best explain the principles of the invention, the practical application, and to enable others of ordinary skill in the art to understand the invention for various embodiments with various modifications as are suited to the particular use contemplated. It will be understood by one of ordinary skill in the art that numerous variations will be possible to the disclosed embodiments without going outside the scope of the invention as disclosed in the claims. Moreover, it should be noted that uses of the phrase “the present invention” within this disclosure are not intended to limit or otherwise restrict the scope of the invention(s) disclosed and claimed by the inventor, but said phrase is merely intended to refer to certain examples of embodiments of the invention(s).

What is claimed is:

1. A method for an enterprise to distribute risk associated with the cost of event tickets, said method at least partially executed on a tangible non-transitory computer usable medium having computer readable program code means embodied therein for causing a computer device to execute one or more steps of said method, the method comprising the steps of:
(a) receiving from a user and storing, with the computer device, information regarding at least one contingent event participant, said user establishing a communication link with the computer device using a communication device;
(b) receiving and storing, with the computer device, information bearing on a probability that said contingent event participant will participate in a future event;
(c) processing, with the computer device, at least said information bearing on the probability that said contingent event participant will participate in a future event, to calculate a premium fee;
(d) processing a transaction involving the payment of said premium fee; and
(e) authorizing the issuance of a certificate of coverage regarding the distribution of risk associated with the probability that said contingent event participant will participate in a future event.

2. The method for an enterprise to distribute risk associated with the cost of event tickets of claim 1, wherein said information bearing on a probability that said contingent event participant will participate in a future event comprises at least one score associated with an event.

3. The method for an enterprise to distribute risk associated with the cost of event tickets of claim 1, wherein said information bearing on a probability that said contingent event participant will participate in a future event comprises data associated with one or more polls.

4. The method for an enterprise to distribute risk associated with the cost of event tickets of claim 1, further comprising the step of processing, with the computer device, information regarding a contingent spectator's event seating preferences, to calculate said premium fee.

5. The method for an enterprise to distribute risk associated with the cost of event tickets of claim 1, further comprising the step of processing, with the computer device, information regarding current ticket pricing information associated with a secondary ticket market, to calculate said premium fee.

6. The method for an enterprise to distribute risk associated with the cost of event tickets of claim 1, further comprising the step of processing, with the computer device, information regarding historical ticket pricing information associated with a secondary ticket market, to calculate said premium fee.

7. The method for an enterprise to distribute risk associated with the cost of event tickets of claim 1, further comprising the step of evaluating, with the computer device, whether the quantity of tickets held in inventory for said future event exceeds a quantity of certificates of coverage entered into by said enterprise that are associated with a contingent event participant having a greater than 0.5 probability of participating in said future event.

8. The method for an enterprise to distribute risk associated with the cost of event tickets of claim 7, further comprising the step of evaluating, with the computer device, whether there is a greater than 0.5 probability that pricing of tickets for said future event on a secondary ticket market will decrease between a current time and a time of said future event; and further comprising the step of, if there is not a greater than 0.5 probability that pricing of tickets for said future event on a secondary ticket market will decrease between the current time and the time of said future event, transmitting an instruction to purchase one or more tickets for said future event.

9. The method for an enterprise to distribute risk associated with the cost of event tickets of claim 1, further comprising the step of receiving a claim associated with said certificate of coverage and confirming whether said contingent event participant will participate in said future event.

10. The method for an enterprise to distribute risk associated with the cost of event tickets of claim 9, further comprising the step of transmitting an instruction to provide a payment pursuant to said certificate of coverage if it is confirmed that said contingent event participant will participate in said future event.

11. A system for distributing risk associated with the cost of event tickets comprising:
(a) a computer having a processor coupled to a memory;
(b) a transceiver for said computer to transmit and receive information from a user;
(c) a database including at least information associated with a contingent participant selected by a contingent spectator,
said information received from said user;
(d) computer software code when executed by the computer causes the computer to:
(i) receive and store information bearing on a probability that said contingent event participant will participate in a future event;
(ii) calculate a premium fee based on at least said probability that said contingent event participant will participate in a future event;
(iii) process a transaction involving the payment of said premium fee; and
(iv) transmit an instruction to issue a certificate of coverage regarding the distribution of risk associated with the probability that said contingent event participant will participate in a future event.

12. The system for distributing risk associated with the cost of event tickets of claim 11, wherein said information bearing on a probability that said contingent event participant will participate in a future event comprises at least one score associated with an event.

13. The system for distributing risk associated with the cost of event tickets of claim 11, wherein said information bearing on a probability that said contingent event participant will participate in a future event comprises data associated with one or more polls.

14. The system for distributing risk associated with the cost of event tickets of claim 11, wherein said database further includes information regarding a contingent spectator's event seating preferences, wherein said seating preferences are received from said user.

15. The system for distributing risk associated with the cost of event tickets of claim 11, wherein said computer code further causes said computer to calculate said premium fee based on current ticket pricing information associated with a secondary ticket market.

16. The system for distributing risk associated with the cost of event tickets of claim 11, wherein said computer code further causes said computer to calculate said premium fee based on historical ticket pricing information associated with a secondary ticket market.

17. The system for distributing risk associated with the cost of event tickets of claim 11, wherein said computer code further causes said computer to evaluate whether the quantity of tickets held in inventory by an enterprise for said future event, exceeds a quantity of certificates of coverage authorized to be issued by said enterprise that are associated with a contingent event participant having a greater than 0.5 probability of participating in said future event.

18. The system for distributing risk associated with the cost of event tickets of claim 17, wherein said computer code further causes said computer to evaluate whether there is a greater than 0.5 probability that pricing of tickets for said future event on a secondary ticket market will decrease between a current time and a time of said future event; and wherein if there is not a greater than 0.5 probability that pricing of tickets for said future event on a secondary ticket market will decrease between the current time and the time of said future event, said computer code transmits an instruction to purchase one or more tickets for said future event.

19. The system for distributing risk associated with the cost of event tickets of claim 11, wherein said computer code further causes said computer to receive a claim associated with said certificate of coverage and confirm whether said contingent event participant will participate in said future event.

20. The system for distributing risk associated with the cost of event tickets of claim 19, wherein said computer code further causes said computer to transmit an instruction to provide a payment pursuant to said certificate of coverage if it is confirmed that said contingent event participant will participate in said future event.
